(19) United States
(12) Patent Application Publication
(10) Pub. No.: US 2008/0300982 A1
(43) Pub. Date: Dec. 4, 2008

(54) METHOD FOR ENABLING THE EXCHANGE OF ONLINE FAVORS

(75) Inventors: L. Scott Larson, Seattle, WA (US); John D. Patton, Seattle, WA (US); Steven J. Gregory, Seattle, WA (US); Joshua E. Bestwick, Seattle, WA (US)

Correspondence Address: DARBY & DARBY P.C., P.O. BOX 770, Church Street Station, New York, NY, 10008-0770, US

(73) Assignee: FriendlyFavor, Inc., Seattle, WA (US)

(21) Appl. No.: 12/129,125

(22) Filed: May 29, 2008

Related U.S. Application Data
(60) Provisional application No. 60/941,208, filed on May 31, 2007.

(51) Int. Cl. G06Q 99/00; G06Q 10/00; G06Q 20/00; G06Q 30/00

(52) U.S. Cl. 705/14; 705/1; 705/27

(57) ABSTRACT

Embodiments are directed to enabling the exchange of online favors. In one embodiment, the system may include a client device connected via a network to a favor management platform. The favor management platform may include a favor management server, web server, billing server, and an advertisement server. A user may enter information detailing a favor to be asked or to be offered. The user further may specify the reward for the favor, including non-monetary rewards, such as good will. The user also specifies whom to send the request or offer for the favor. The favor management server generates favor page, with the set of contacts. A notification message regarding the favor page is sent to the set of specified contacts. Once received, a contact may view the favor page, providing comments and/or responses. The user may provide the reward to a contact(s) that satisfy the favor.

### CROSS-REFERENCE TO RELATED APPLICATIONS

This application claims the benefit of U.S. Provisional Application Ser. No. 60/941,208 filed on May 31, 2007, entitled “Method For Enabling The Exchange Of Online Favors,” the benefit of the earlier filing date of which is hereby claimed under 35 U.S.C. §119(e) and 37 C.F.R. §1.78, and is further incorporated herein by reference in its entirety.

### FIELD

The present invention relates generally to electronic exchanges and, more particularly, but not exclusively, to enabling the exchange of favors through online forums.

### BACKGROUND

The growth of the Internet has brought a corresponding increase in the number and variety of ways good and services are exchanged. Today, when users wish to buy or sell goods, they may turn to a variety of online websites for aid. For example, virtual bulletin boards, such as craigslist.com, have become popular in many large cities around the nation. These bulletin boards allow users to publicly post items for sale or rent, requests for items to purchase, job opportunities, community involvement opportunities, or the like. Some sites, such as Ebay, and the like, provide environments that allow users to conduct an auction for various products. In addition, other types of websites allow for centralized event organization. These invitation websites, such as Evite, provide web-based RSVP services for event planners. A third type of website, such as MySpace, Facebook, Friendster, LinkedIn, or the like, provide networking among social groups, allowing people to talk with other people or meet people through their direct friends and coworkers.

With the expansion of the Internet comes the question of how to take advantage of the growing flow of information. Virtual bulletin boards provide no way for a user to control who views or responds to posts. Centralized event organization websites is limited to invited users and static, planned event RSVPs. Social networking websites provide ample user control over social networks, but do not provide services to aid in the exchange of goods and services. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 shows a functional block diagram illustrating one embodiment of an environment for practicing the invention;

FIG. 2 shows one embodiment of a mobile device useable as a client device within the environment of FIG. 1;

FIG. 3 shows one embodiment of a network device useable as a favor management server, web server, billing server, or advertisement server within the environment of FIG. 1;

FIG. 4 illustrates a screenshot showing one embodiment of an entry page into the favor management platform;

FIG. 5 illustrates a screenshot showing one embodiment of a summary page of a user's favors;

FIGS. 6A-6B illustrate a screenshot showing one embodiment of a user interface for asking a favor;

FIGS. 6C-6D illustrate a screenshot showing one embodiment of a user interface for offering a favor;

FIG. 7 illustrates a screenshot showing one embodiment of a user interface for a favor preview page;

FIG. 8 illustrates a screenshot showing one embodiment of a notification message regarding an available favor;

FIG. 9 illustrates a screenshot showing one embodiment of a favor page with discussion area;

FIG. 10 illustrates a logical flow diagram generally showing one embodiment of a process for managing favors;

FIG. 11 illustrates a logical flow diagram generally showing one embodiment of a process for entering favor details;

FIG. 12 illustrates a logical flow diagram generally showing one embodiment of a process for publishing a favor;

FIG. 13 illustrates a logical flow diagram generally showing one embodiment of a favor type and value selection process;

FIG. 14 illustrates a logical flow diagram generally showing one embodiment of a process for providing recommendations;

FIG. 15 illustrates a logical flow diagram generally showing one embodiment of a process for acquiring revenue for the exchange of favors;

FIG. 16 illustrates a logical flow diagram generally showing one embodiment of a process for targeting advertisements within a favor page;

FIG. 17 illustrates a logical flow diagram generally showing one embodiment of a process for searching for favors within the favor management platform;

FIG. 18 shows one embodiment of a favor template selection; and

FIG. 19 illustrates a use case flow diagram showing one embodiment of a set of user scenarios within the favor management platform.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, processes, or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “favor” refers to any form of request for a transfer of a good, service, and/or good will that may be communicated over a network among a defined group of selected or known contacts in exchange for a reward. A favor may be asked or offered by the requester of the favor. Favors may therefore include, but are not limited to, requests for specialists, referrals, jobs, or the like, items to buy, sell, give away, donate, or the like, requests for recommendations, fund raising, event organization, exchange of skills or items, or the like. Typically, favors are presented to a defined group of contacts known to the requestor of the favor. However, favors may also be available to the general public. In exchange for a favor, the requestor of the favor may provide the grantor of the favor with a reward.

As used herein, the term “reward” refers to any transfer of a good, service, and/or good will received in exchange for a favor. Rewards may include, but are not limited to, monetary payments, gift cards, donations to one or more charities, return favors, goodwill, or the like.

The following briefly describes the invention in order to provide a basic understanding of some aspects of the invention. This brief description is not intended as an extensive overview. It is not intended to identify key or critical elements, or to delineate or otherwise narrow the scope of the invention. Its purpose is merely to present some concepts in a simplified form as a prelude to the more detailed description that is presented later.

Briefly stated the present invention is directed towards a method, system, and apparatus for enabling the exchange of online favors by providing incentives for processing favors. In one embodiment, the system may include a client device connected via a network to a favor management platform. The favor management platform may include, but is not limited to a favor management server, web server, billing server, advertisement server, and the like. Moreover, one or more of these components may be combined into a single network device, or similarly, be distributed across a plurality of network devices. A user wishing to ask a favor may log-in to the favor management platform. Once logged in, the user may enter information detailing the favor to be asked. Favor details may include a favor title, description, reward type, reward value, time constraints, privacy preferences, personal notification level, type of notification, display options, or the like. Reward types may be in the form of cash, gift cards, charitable donations, return favors, good will, or the like.

The user may then preview the generated favor page, upload a set of contacts, and, if acceptable, publish the favor page. Contacts may be entered manually, imported from an address book within the favor management platform, imported from an external social networking site such as MySpace, Friendster, Facebook, LinkedIn, or the like, imported from an address book from an external email client, or the like. The favor page may serve as a temporary site, lasting for the duration of the favor, or lasting indefinitely in an archive. The favor management server may then generate a notification message regarding the favor page to be sent to the contacts. Notification messages may be in the form of an email, a text message, an SMS message, a message on a pager, a voicemail, an alert from a management interface in the form of a pop up, sound, notifier, or the like, no notification, or the like. Once received, a contact may view the favor page, providing comments or responses as appropriate. A user may elect to receive notifications when a contact modifies the favor page. For example, a user may receive an alert on a pager, a text message, an email, a voice mail, a pop-up alert on a computer, no notification, or the like. If a contact completes a favor, the user may provide the posted reward to the contact.

In one example, a user may create a favor asking for a recommendation for a painter costing under $300. The user may request that the favor be answered within the next three days and offer a round of drinks as the reward. The user may further request that the favor be confined to direct contacts and friends of contacts. When a contact posts a response to the favor page, the user may elect to receive an email message. When the user locates a painter, the user may close the favor and notate to whom the round of drinks is owed. Note that the invention is not limited to this embodiment. One of skill in the art will recognize that the favor may be directed to another favor. In another embodiment, the request may be answered within a different amount of time, such as four hours, two weeks, one year, or the like. The reward may be in the form of an amount of cash, a gift card, a donation, a return favor, or the like. The reward may also increase in value with time until it reaches a cap established by the favor's creator. If the reward is a return favor, the favor management platform may track to whom the return favor is owed. A user may also send a favor just to contacts, post publicly within the favor management platform, or the like.

It is noted that while in one embodiment, the platform described herein may be implemented as a stand alone system, the invention is not so limited. For example, in another embodiment, the platform may be configured to provide an open interface where other systems, websites, or the like, can integrate with and or otherwise leverage the inventive platform's approach for exchanging favors as described herein.

### Illustrative Operating Environment

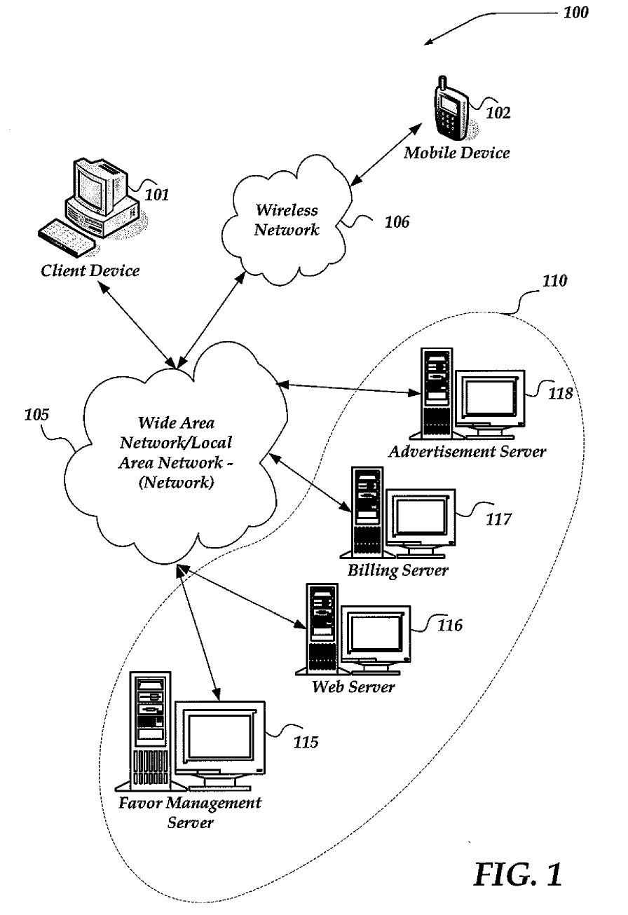

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 106, Favor Management Platform 110, Favor Management Server 115, Web Server 116, Billing Server 117, Advertisement Server 118, mobile (wireless) device 102, and client device 101.

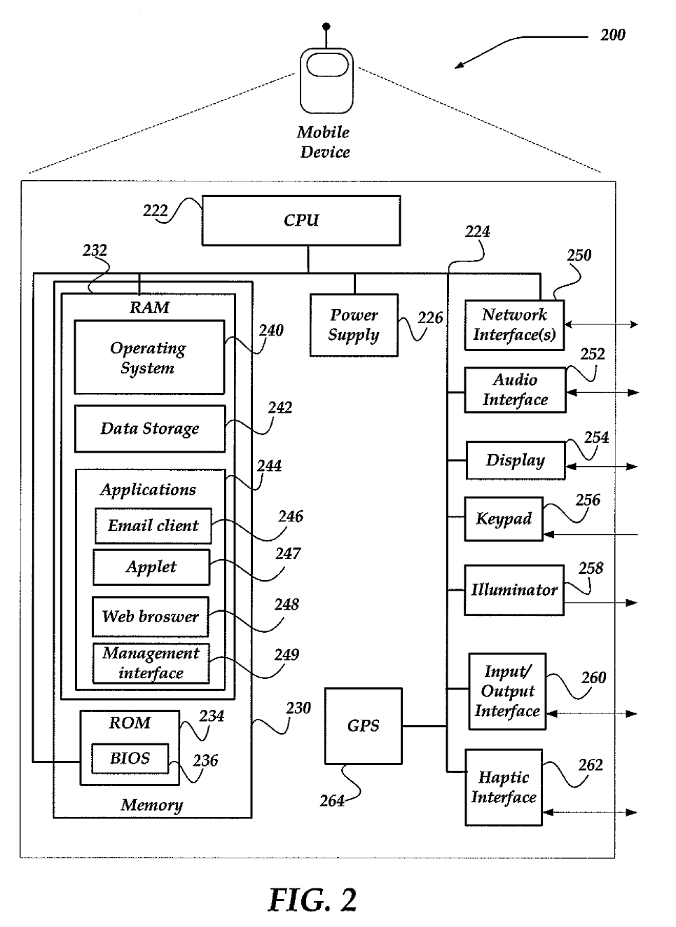

One embodiment of mobile device 102 is described in more detail below in conjunction with FIG. 2. Generally, however, mobile device 102 may include virtually any portable computing device capable of receiving and sending a message over a network, such as network 105, wireless network 110, or the like. Mobile device 102 may also be described generally as client devices that are configured to be portable. Thus, mobile device 102 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. As such, mobile device 102 typically ranges widely in terms of capabilities and features. For example, a cell phone may have a numeric keypad and a few lines of monochrome display on which only text may be displayed. In another example, a web-enabled mobile device may have a touch sensitive screen, a stylus, and several lines of a color display in which both text and graphics may be displayed.

Mobile device 102 may further be configured to include a client application that enables an end-user to log-in to a membership account on platform 110 that includes servers 115, 116, 117, and 118. Such an end-user membership account, for example, may be configured to enable one or more activities, including: enabling the member to ask favors of other members or non-members; enabling the member to view a favor asked by another member; manage favors both asked by and to the member; manage a membership account; search an archive of favors; and the like. However, participation in at least some of these activities may also be performed without logging into the end-user membership account. Additionally, mobile device 102 may also communicate with non-mobile (wired) client devices, such as client device 101, or the like.

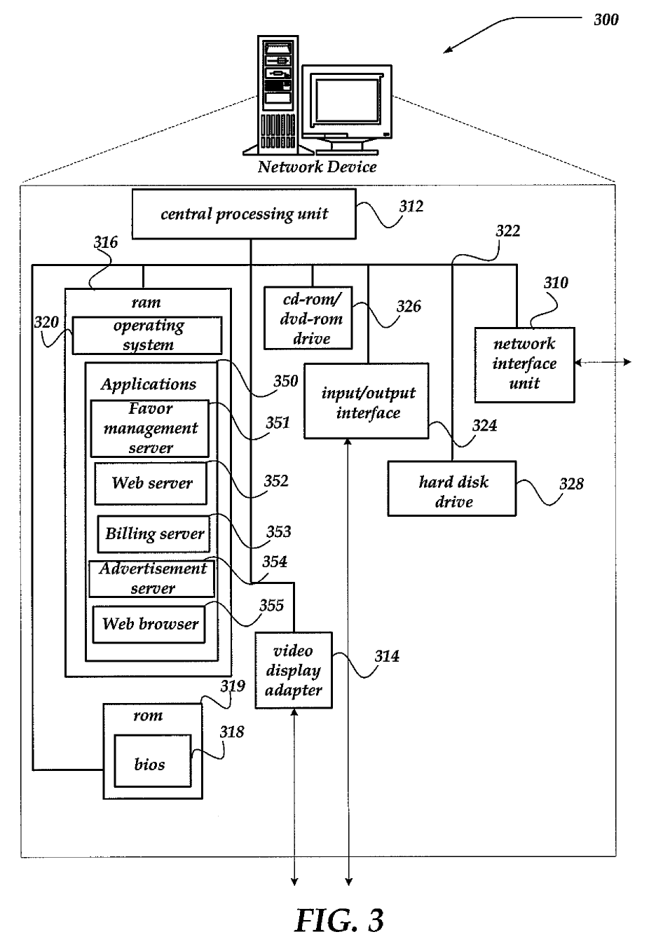

Client device 101 may include virtually any computing device capable of communicating over a network to send and receive information, such as network device 300 shown in FIG. 3, or the like. The set of such client devices may include devices that typically connect using a wired or wireless communications medium such as personal computers, multiprocessor systems, microprocessor-based or programmable consumer electronics, network PCs, or the like.

Wireless network 106 is configured to couple mobile device 102 and its components with communication provided over network 105. Wireless network 106 may include any of a variety of wireless sub-networks that may further overlay stand-alone ad-hoc networks, and the like, to provide an infrastructure-oriented connection for mobile device 102. Such sub-networks may include mesh networks, Wireless LAN (WLAN) networks, cellular networks, and the like.

Wireless network 106 may further employ a plurality of access technologies including 2nd (2G), 3rd (3G), and 4th (4G) generation radio access for cellular systems, WLAN, WiMax, Wireless Router (WR) mesh, and the like. Access technologies such as 2G, 3G, 3G, and future wireless access networks may enable wide area coverage for mobile devices, such as mobile device 102 with various degrees of mobility. For example, wireless network 106 may enable a radio connection through a radio network access such as Global System for Mobil communication (GSM), General Packet Radio Services (GPRS), Enhanced Data GSM Environment (EDGE), Wideband Code Division Multiple Access (WCDMA), Universal Mobile Telephone System (UMTS), and the like. In essence, wireless network 106 may include virtually any wireless communication mechanism by which information may travel between mobile device 102 and another computing device, network, and the like.

Network 105 is configured to couple platform 110 and its servers with other computing devices, including, client device 101, and through wireless network 106 to mobile device 102. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between platform 110, client device 101, and other computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

Platform 110 may also include a variety of services used to provide services to remotely located members. Such services include, but are not limited to web services, third-party services, audio services, video services, email services, IM services, SMS services, MMS services, VOIP services, video game services, blogs, chat rooms, gaming services, calendaring services, shopping services, photo services, or the like. Although FIG. 1 illustrates platform 110 including servers 115, 116, 117, and 118 as physically separate computing devices, the invention is not so limited. For example, one or all of the servers can be operated on one computing device, without departing from the scope or spirit of the present invention. Also, devices that may operate as platform 110 include personal computers, desktop computers, multiprocessor systems, microprocessor-based or programmable consumer electronics, network PCs, servers, and the like.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile device 102 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), Wide CDMA (CDMA), time division multiple access (TDMA), Universal Mobile Telephone Service (UMTS), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 236 for controlling low-level operation of mobile device 200. The mass memory also stores an operating system 240 for controlling the operation of mobile device 200. It will be appreciated that this component may include a general purpose operating system including, but not limited to a version of UNIX, or LINUX™, a specialized client communication operating system such as Windows Mobile™, the Symbian® operating system, Google's Android mobile operating system, or the like. The operating system may include, or interface with a Java Virtual Machine (JVM) module that enables control of hardware components and/or operating system operations via Java application programs.

Memory 230 further includes one or more data storage 242, which can be utilized by mobile device 200 to store, among other things, applications 244 and/or other data. For example, data storage 242 may also be employed to store information that describes various capabilities of mobile device 200. The information may then be provided to another device based on any of a variety of events, including being sent as part of a header during a communication, sent upon request, or the like.

Applications 244 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, video games, gaming programs, search programs, shopping cart programs, and so forth. Applications 242 may further include web browser 248. The web browser application may be configured to receive and display graphics, text, multimedia, and the like, employing virtually any web based language, including a wireless application protocol messages (WAP), and the like. In one embodiment, the browser application for the mobile device is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display content and communicate messages.

Web browser 248 may be configured to receive and enable a display of rendered content provided by platform 110. Further, web browser 248 enables the user of mobile device 200 to select different actions displayed by the rendered content. In at least one embodiment, web browser 248 enables the user to select one or more of a product to purchase, search for content and display the result, call a mobile telephonic device, display and respond to messages, or the like.

Applications 242 may further include email client 246, applet 247, and management interface 249. The email client application may be configured to receive email notifications from the favor management platform 110. The email client may be a widely available email client such as MICROSOFT Outlook, Eudora, or the like, or may be part of web browser 248. In this case, a user may access email through a web mail interface within web browser 248. Management interface 249 may be an applet 247 providing notifications from favor management platform 110. However, the invention is not constrained to use of an applet, and other mechanisms for providing notifications may also be used, including, without limit, scripts, plug-ins, widgets, programs, web pages, or the like.

### Illustrative Network Device

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, favor management server 115, web server 116, billing server 117, advertisement server 118, and/or client device 101 of FIG. 1.

Network device 300 includes processing unit 312, video display adapter 314, and a mass memory, all in communication with each other via bus 322. The mass memory generally includes RAM 316, ROM 319, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also may communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of processor-readable storage media. Processor readable storage media may include volatile, nonvolatile, removable, and non-removable media implemented in any method or technology for storage of information, such as processor readable instructions, data structures, program modules, code, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed and read by a processor for a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Favor management server 351, web server 352, billing server 353, advertisement server 354, and web browser 355 may also be included as an application program within applications 350. Also, favor management server 351, web server 352, billing server 353, and advertisement server 354, may be configured as a platform for providing favor management services to users that have signed up as a member.

Briefly, favor management server 351 may be configured and arranged to provide a system for users to exchange favors through online forums. As such, favor management server 351 may be configured to provide user interfaces, widgets, templates, and the like, that enable a user to ask for favors, respond to requests for favors, manage rewards, and/or otherwise manage exchanges of favors online with other users. Favor management server 351 may employ processes such as those described below to perform at least some of its actions. Moreover, favor management server 351 may provide various user interfaces for users to manage favors, such as those described in more detail below. Thus, favor management server 351 may interact with web server 352 to provide the user interfaces, and to interact with users.

Favor management server 351 may also interact with advertisement server 354 to provide targeted advertisements to users. As such, advertisement server 354 might be configured and arranged to manage selection of the advertisements, and/or to store advertisements for use in displaying on a favor page.

Favor management server 351 may also interact with a messaging server, such as an email server, instant messaging server, or even a messaging component that interacts with web server 352 for sending/receiving messages associated with the exchange of favors.

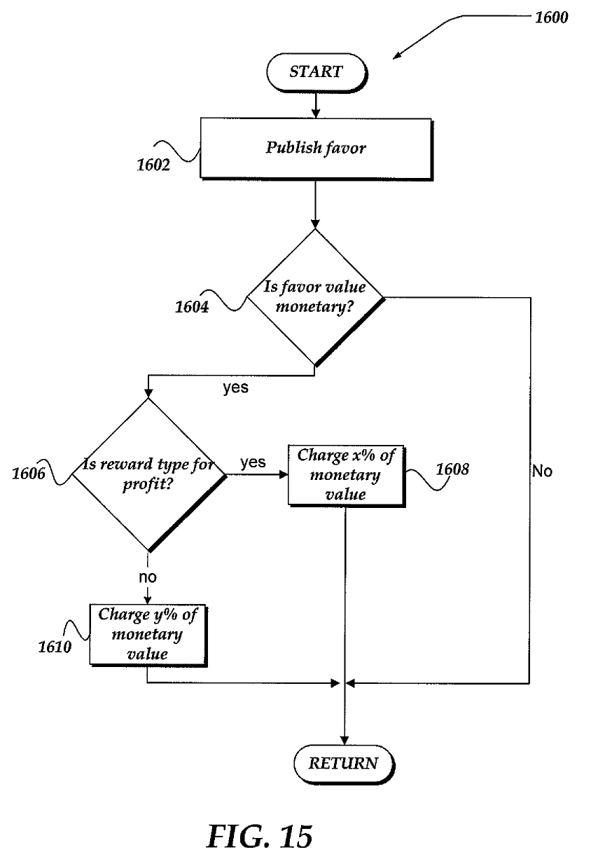

Billing server 353 may be configured and arranged to interact with favor management server 351 for managing rewards associated with favors. As such, billing server 353 may be configured to determine an amount of value for a favor and to manage charges based on the determined value to a user. One embodiment of billing server 353 may employ a process such as described in more detail below in conjunction with FIG. 15 to perform at least some of its actions.

### Illustrative User Interfaces

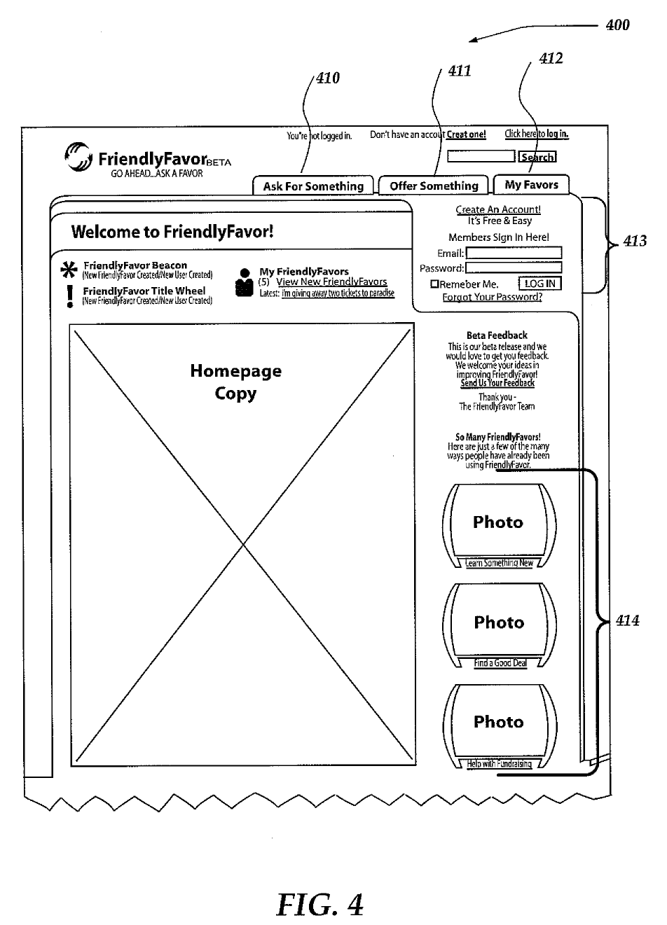

Illustrative user interfaces of certain aspects of the invention will now be described with respect to FIGS. 4-9. FIGS. 4-9 may include many more or less components than those shown in. However, the components shown are sufficient to disclose illustrative embodiments for practicing the invention. Moreover, it should be understand that the location, size, shape, orientation, or the like, of illustrated components are not to be construed as narrowing the scope of the invention, and other layouts of the interfaces may also be employed.

FIG. 4 shows a diagram of one embodiment of an entry user interface 400 for allowing a user to access the favor management platform. Shown are three possible entry points, “Ask for Something” 410, “Offer Something” 411, and “My Favors” 412. Other entry points, such as “Respond to a Favor,” “Search Favors,” or the like, may also be provided on entry user interface 400. In one embodiment, from entry user interface 400, a separate log-in webpage may be displayed when a user select to employ the “Sign In” 413 window. In addition, template column 414 includes a series of non-exhaustive icons directed to various ways of accessing favors. For example, in one embodiment, a user may wish to find a specialist, buy a product or service, sell a product or service, request a referral, request a recommendation, assist with fund raising, organize a group or event, swap a product or service, anything general, or the like. However, the invention is not limited by these examples. For example, template bar 414 may also include an advice icon for users who wish to learn a skill, or the like, an assistance icon for users who wish to receive physical help from their contacts, an exchange icon for users who wish to offer a favor in exchange for another favor, or the like.

In one embodiment, template column may provide an icon into one or more lists of swappable favors. Such swappable favors may include, but is not limited to help swaps, information swaps, services swaps, swaps on items, goods, or the like. Thus, in one embodiment, one or more users might develop an inventory of swappable favors. These swappable inventories might then operate similar to currency or other bartering mechanism that can be used to swap with another for a favor, a reward, or the like. For example, a user might have a set of baseball cards, or other collectables, that they are willing to swap for some other collectable, a service, or the like. The invention is not limited to this example, however, and other uses of the swap shop may also be employed, without departing from the scope of the invention.

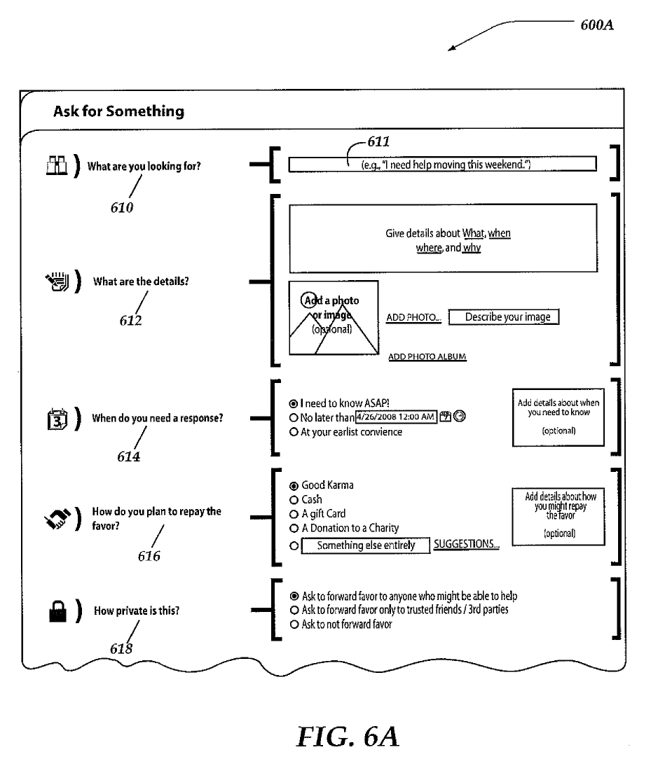

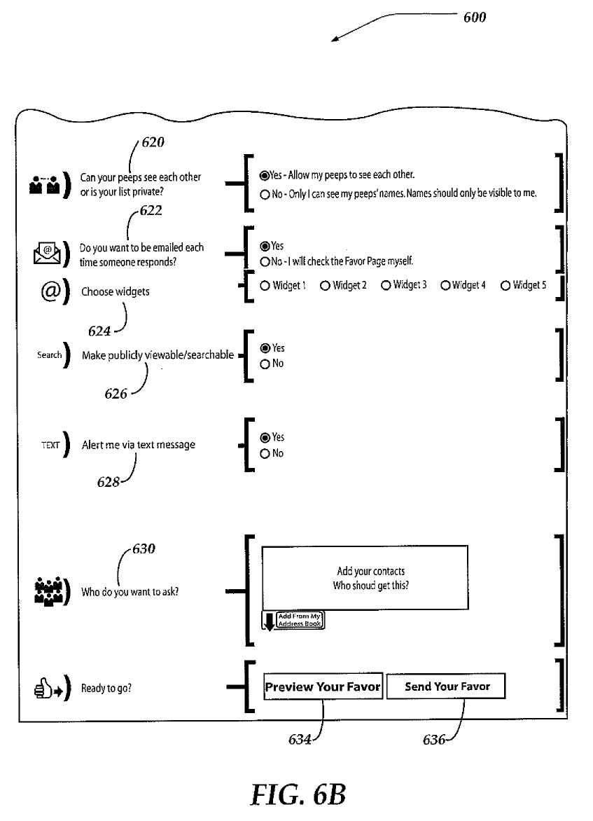

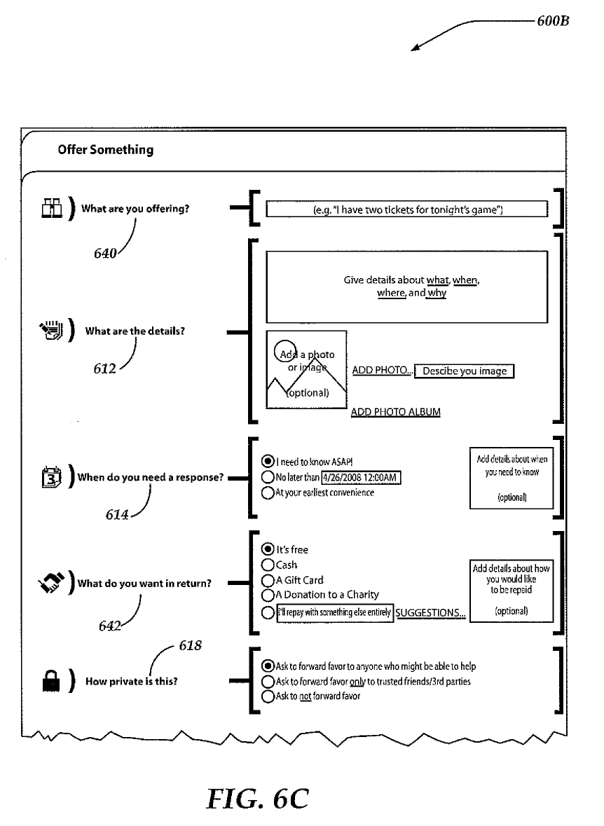

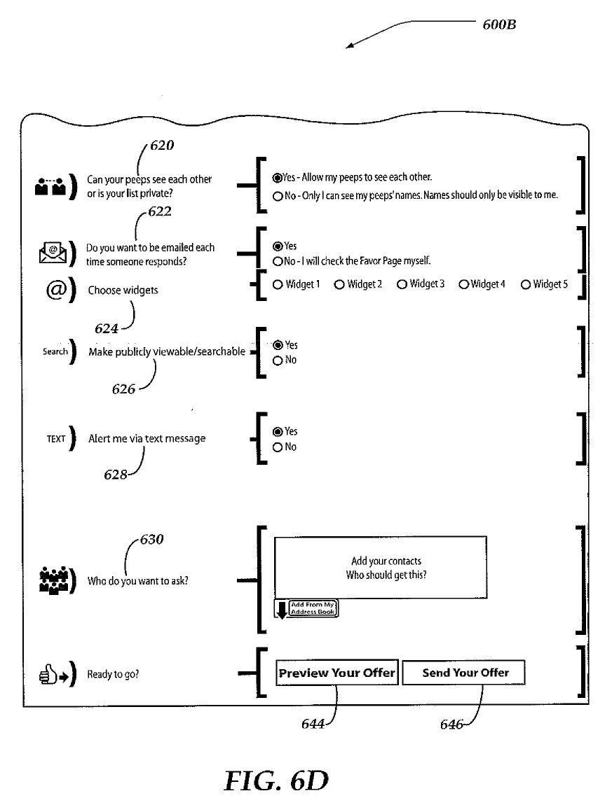

When an icon is selected from template bar 414, a favor input user interface may be generated from a template geared toward the chosen favor category. One embodiment of a favor input user interface is described in more detail below in conjunction with FIG. 6.

Entry user interface 400 may also include sample favors taken from a set of publicly available favors to educate users about various ways favors may be used. Sample favors may be displayed as thumbnails, textual links, graphical icons, pictures, or the like. The sample favors may additionally be populated by new types of favors, popular favors both within the entire favor management platform favors and/or within a set of favors known to the user, highest paid reward favors, relationship similarity, or difference to previously viewed/answered favors for a signed in user, paid advertisement favors, user preference, or the like. However, the invention is not limited by this embodiment. For example, these sample favors may change as a user visits the favor management platform more frequently. In one embodiment, the sample favors may include favors in a particular interest area to the user. If a user visits several “buy” favor pages, several favor pages related to a particular topic, or the like, the sample favors may include more “buy” public favors, favors related to the particular topic, or the like. In another embodiment, the sample favors may include favors outside a particular interest area to the user to expand their knowledge of the uses of favors. For example, if a user has not previously visited a flud-raising favor page, the sample favors may include a fund-raising favor.

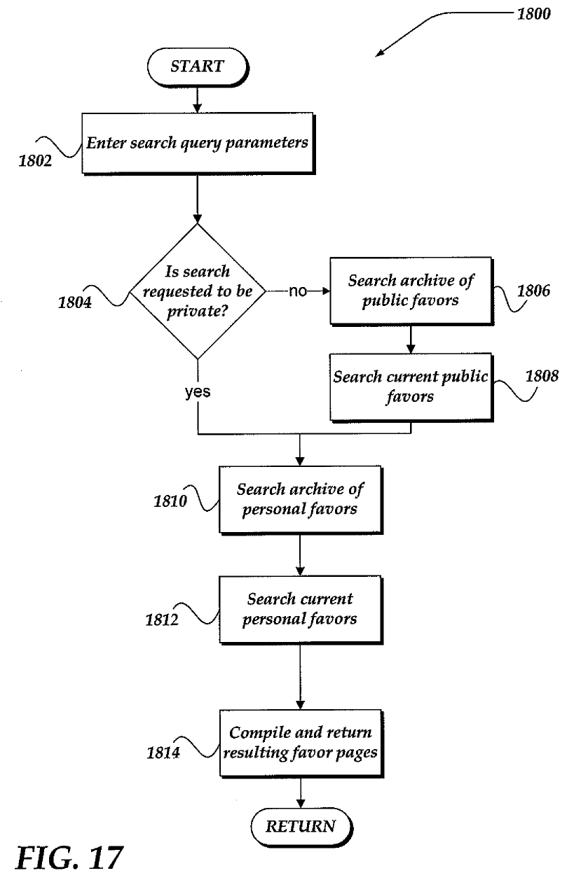

In another embodiment, the sample favors may be grouped by category, similar to template bar 414. Categories may include, but are not limited to, finding a specialist, buying a product or service, selling a product or service, requesting a referral, requesting a recommendation, assisting with fund raising, organizing a group or event, seeking assistance, exchanging a skill, or the like. In one embodiment, a user may select a sample favor in a category to perform a search of all public favors. One embodiment of a process useable to perform a search of favors is described in more detail below in conjunction with FIG. 17.

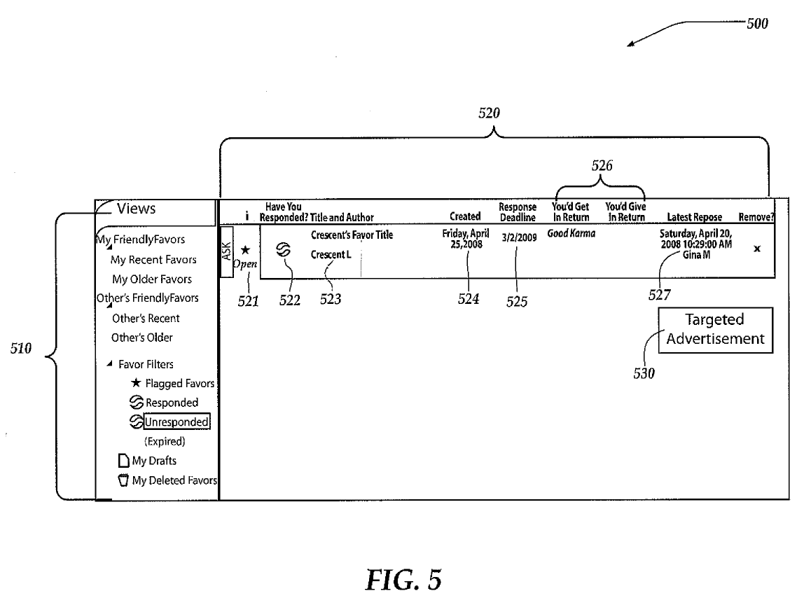

In one embodiment, a user may select a “buy” sample favor. In return, a user may receive a listing of all public “buy” favors within the favor management platform. However, the invention is not limited to this embodiment. Other categories of favors may be searched within the scope of the invention. The listing of favors may be displayed in a favor view interface, such as described in more detail below in conjunction with FIG. 5.

FIG. 5 illustrates a diagram of one embodiment of a favor list interface 500 for displaying information regarding current favors. As shown, information 520 regarding the current favors available to the user may be displayed to a user. Such information 520 may include, but is not limited to a status of favor (open, closed and fulfilled, closed and unfulfilled, on hold) 521, whether or not the user has responded to the favor 522, title and author of favor 523, creation date and time of favor 524, response deadline for favor 525, reward of the favor 526, latest response date and time of the favor 527, or the like. The type of information 520 is not constrained to these non-exhaustive examples of information, and other information may also be displayed.

In one embodiment, the current favors are a list of favors requested of a user. In another embodiment, the current favors may be favors that the user has requested. In another embodiment, the current favors may be drawn from a set of publicly available favors. As described above with respect to template bar 414, the list of current favors may change based on a user's preferences. In another embodiment, current favors may be a listing of search results. Favor list interface 500 may also include controls to specify filter criteria 510 and sorting criteria 520. Moreover, in at least one embodiment, targeted advertisement 530 may also be displayed to the user within favor list interface 500, without departing from the scope of the invention. Again, it is noted that the arrangement of the various illustrated components is not limited to that layout shown, and other arrangements are also possible. Thus, the scope of the invention is not to be construed as being narrowed by the non-exhaustive illustration.

FIGS. 6A-6B illustrate a screenshot showing one embodiment of a user interface for asking a favor, while FIGS. 6C-6D illustrate a screenshot showing one embodiment of a user interface for offering a favor.

Thus, user interface 600A of FIGS. 6A-B may include a variety of types of information that a user might employ while asking for a favor. For example, the favor management platform may request information including “what are you looking for” 610, “what are the details” 612, “how do you plan to repay the favor” 616, “how private is this” 618, “can peeps see each other” 620, “want to be emailed” 622, “choose widgets” 624, “make public” 626, “alert via text message” 628, “who to ask” 630, and “ready to go” selection categories for a user asking for a favor.

It should be noted that, as shown, user interface 600A may be shown within a single scrollable browser window. However, the invention is not so limited. For example, selection of any one of the categories above might open another window, frame, menu, or the like. Moreover, in another embodiment, user interface 600A might also be split across multiple display screens based on any of a variety of other criteria. Thus, the invention is not to be construed as limited by the non-exhaustive illustration. In addition, the order, flow, or arrangement of the category selections are not to be limited by the illustration, and other arrangements are also possible.

In any event, in one embodiment, as shown, each category may provide a variety of selections for the user. For example, “what are the details” 612 may allow a user to input a photo or other image, describe the image via text, or the like, and/or attach a document, specify an associated website address, and/or provide details about the favor being requested, including, but not limited to what, when, where, why, or the like.

Moreover, at least some of the categories of information requested may be modified based on, at least in part, a template chosen from template bar 414 shown in FIG. 4. For example, a fund-raising template may provide in addition to, or in place of an illustration category, a money meter (such as a thermometer, gauge, dial, window, or the like) to indicate portion of funds collected and may request a goal amount. However, the invention is not limited to this embodiment and other types of information may be requested based on the template chosen.

As shown, looking for 610 may provide an interface 611 that may be implemented as a window, text bar, pull down, or the like, that enables the user to enter text, or the like, indicating what favor the user is looking for.

Need response 614 provides user selection options that enable the user to indicate when the user would like a response to the favor. Any of a variety of input mechanisms may be used, including, but not limited to icons, buttons, fill-in the blanks, pull-down date selectors, or the like. In one embodiment, the user may be provided with an interface useable to add details about when the user needs/wants a response. In one embodiment, the user might enter a rationale for the date.

How do you plan to repay 616 may include several options such as cash, gift card, good will (“Good karma”), or the like. However, the invention is not limited to these favor values for repayment. For example, repay 616 may include a donation to a particular charity, a return suggestion, a return favor, something else entirely, or the like. In one embodiment, if a donation, gift card, or the like reward type is chosen, featured vendors may be available in a drop down menu. Further, a user may set a preference to include or exclude a particular vendor. Also, the favor management platform may provide previously used vendors (by a user) to the particular user for future use.

How private 618 is configured to enable a user to select how private the request for the favor may be. As such, the user might be able to select from a variety of predefined selections that the how private the request is. However, in another embodiment, the user might be provided with an interface where the user might be able to type in an explanation or other criteria useable to identify how private the favor is.

Moreover, the user might also be provided with further granularity for selecting privacy criteria on the request for the favor. For example, peeps 620 might be provided to allow the user to identify whether other “people” can see each other's responses to the request for the favor. The user may also be allowed to make publicly searchable and/or viewable the favor.

User interface 600A may also enable a user to identify how and/or when to notify the user about responses. For example, in one embodiment, the user might be provided with an email 622 selection that allows the user to indicate whether to email the user each time a response to the request for a favor is received. However, in another embodiment, the user might also indicate whether to have a text message sent using the alert via text message 628 selection. The invention is not limited to these communication selections, and others may also be provided, without departing from the scope of the invention.

Choose widgets 624 may include a variety of suggested widgets including, but not limited to, a calendar, a spreadsheet, a checklist, a money meter, a map, a carpool organizer, or the like. Choose widgets 624 may also include additional widgets. In one embodiment, Choose widgets 624 may include an upload button, link, or the like allowing the user to upload their own widget. In another embodiment, Choose widgets 624 may include a browse button, link, or the like to browse a set of available widgets.

User interface 600A also provides the user with whom to ask 620 selection category. This selection is directed towards enabling the user to specify the set of members or contacts for which the request for a favor is to be sent.

In one embodiment, add who to ask 620 may include a text box to type contact email address. However, the invention is not limited to this embodiment. For example, contacts may be entered manually, imported from an address book within the favor management platform, imported from an external social networking site such as MySpace, Friendster, Facebook, LinkedIn, or the like, imported from an address book from an external email client, or the like. In one embodiment, who to ask 620 may include buttons, links, or the like to automatically access outside address books and upload contacts. At any time during or upon completion of entering user selections, an option to preview the favor 634 or send the favor 636 may be used to preview or submit the selections for generating the request for a favor.

FIGS. 6C-6D illustrate a screenshot showing one embodiment of a user interface for offering a favor. As may be seen in the figures, user interface 600B enables a user to offer a favor. Thus, user interface 600B includes substantially similar selection categories useable to generate the offer. Moreover, similar to user interface 600A, user interface 600B may also be displayed within a scroll down window, within frames, pop up menus, selectable screens, or the like. Moreover, the invention is not limited by the arrangement and/or illustrated selections, and other selections and/or arrangements of selections are also envisaged.

In any event, user interface 600B includes, but is not limited to looking for 610, what are the details 612, need response 614, how private 618, peeps 620, emailed 622, choose widgets 624, make public 626, alert via text message 628, who to ask 630, and the like, each of which operate substantially similar to the selections described above in user interface 600A.

User interface 600B may also include what are you offering 640 selection that enables the user to input a description of what favor the user wishes to offer. The description may be typed in, cut and paste from another source, or entered using any of a variety of mechanisms, including, but not limited to selecting from a menu of choices. User interface 600B may further allow the user to specify what is wanted in return for the favor using return 642 selection. Moreover, similar to user interface 600B, the user is provided with a preview 644 selection and a send your offer 646 selection.

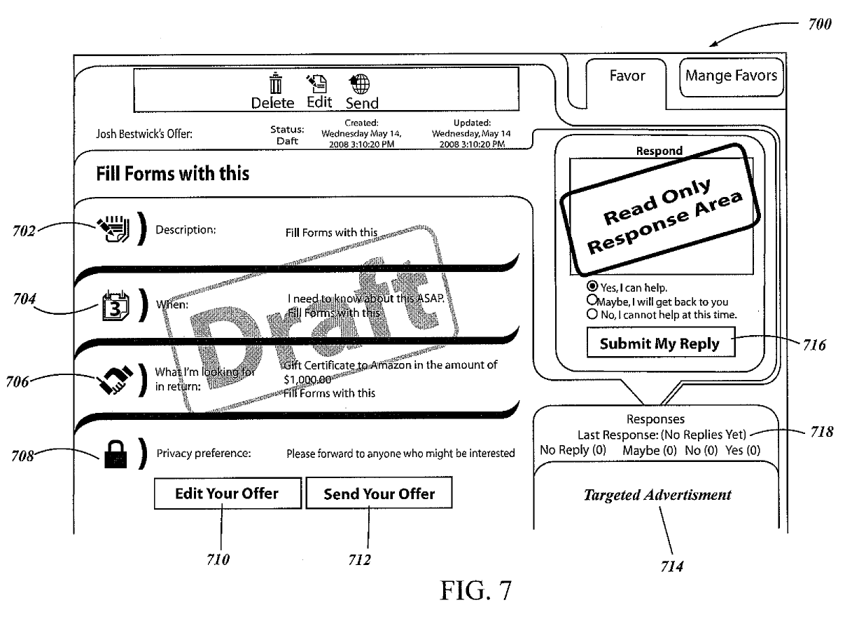

FIG. 7 illustrates a diagram of one embodiment of a favor preview page 700 that may be generated, for example, by selecting the “preview” button in FIGS. 6A-B. For example, the information entered into favor input user interface 600A may be displayed, including, but not limited to description 702, need response 704, exchange 706, and/or privacy preferences 708. It should be clear that other information selected by the user may also be displayed in addition to and/or in place of at least one of the illustrated selections. Thus, additional information, such as a widget (for example the money meter described above for a fund-raising favor) may optionally be included. However, the invention is not limited to this embodiment and other types of information may be included based on the template chosen or options selected when the favor was created.

Favor preview page 700 may also include an edit selector 710, and a send your offer selector 712, useable to enable the user to continue to edit their selections, or, for sending (publishing) the favor page once favor preview page 700, respectively.

In one embodiment, preview page 700 may also illustrated a layout providing the user with a view of information such as how another user's reply might be submitted (submit selector 716), and/or where another user's responses 718 might be displayed.

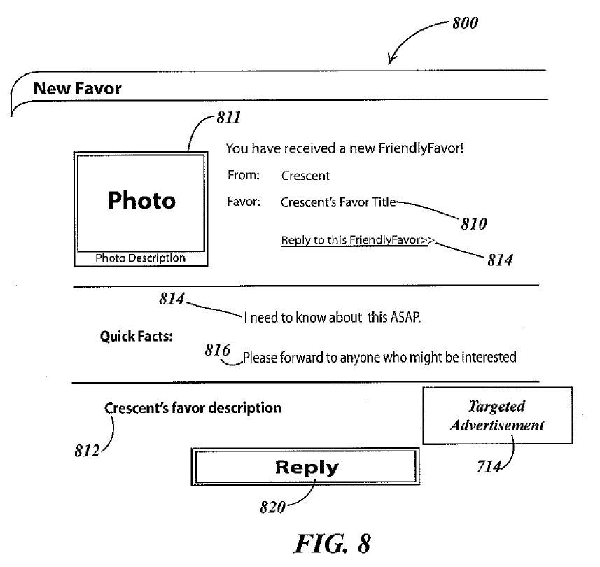

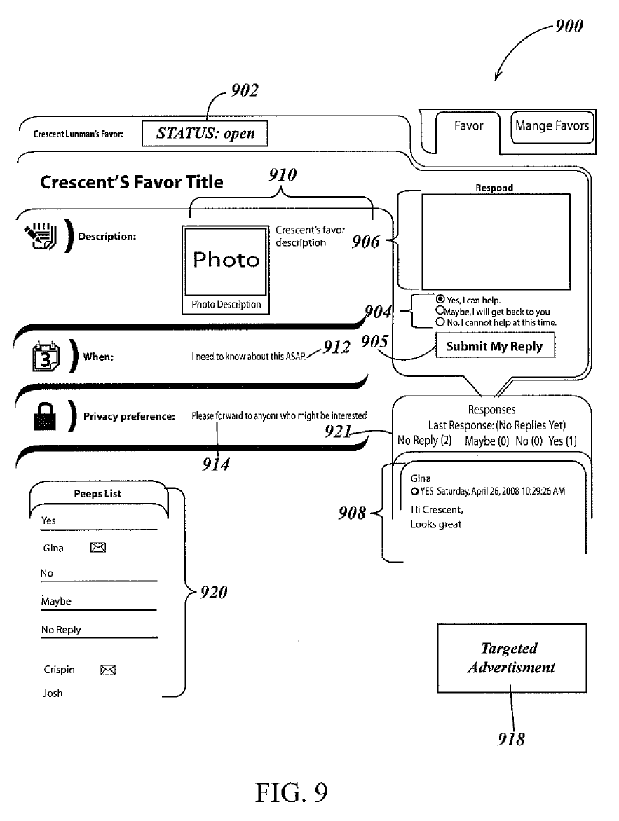

In still another embodiment, the platform might select and display a targeted advertisement 714 to the user that is selected based at least in part on the information the user submitted in preparing the request. The advertisement might be targeted to the user in one embodiment, or be generated for targeting the viewers of the user's request. Moreover, in another embodiment, targeted advertisement 714 may represent a location for which the user might select for use in identifying an advertisement for display to others. In one embodiment, the selection of the advertisement by the user, and consent to have such advertisement be displayed may enable the user to receive additional compensation for participating in favor exchange. In still another embodiment, the request, including preview page 700 and the favor notification 800 of FIG. 8, might not include display of targeted advertisement 714. In any event, one embodiment of a favor page is described in more detail below in conjunction with FIG. 9.

FIG. 8 illustrates a diagram of one embodiment of a favor notification 800 that may be generated, for example, by selecting the “send favor” selector illustrated in FIG. 7. For example, the information entered into favor input user interface 600A-600B may be displayed, including a favor title 810, a favor photo 811, favor value and description 812, a response date 814, a privacy preference 816, a link 814 to a favor page generated by selecting the “send your favor” button in FIG. 7, or the like. Favor notification 800 may also provide the recipient with a reply selector 820 that allows the recipient to reply to the notification. In one embodiment, the link 814 may also provide a user with a link to a website for which the recipient may also use to reply to the notification, view more information about the favor, or the like.

As described above, in one embodiment, favor notification 800 might include targeted advertisement 714 where the targeted advertisement is selected based on the favor requestor's preferences, based on information about the notification recipient, or the like. In still another embodiment, targeted advertisement 714 might not be included within favor notification 800.

Additional information, such as favor widgets, for example, the money meter described above for a fund-raising favor, a favor description, or the like, may also be included. Favor notification 800 may be in the form of an email message, text message, SMS message, instant message, MMS message, voice mail, or the like. However, the invention is not limited to this embodiment and other types of notifications may be used. For example, notifications may be provided in the form of an alert. The user may install a management interface application such as management interface 249 described in conjunction with FIG. 2. The favor management platform may notify the management interface application of an available favor. The management interface application may then provide an alert to the intended recipient in the form of a sound, pop up, notifier, and/or the like. The sound, pop up, notifier, and/or the like may include a message regarding the available favor, and/or a link to the message, website, or the like.

FIG. 9 illustrates a diagram of one embodiment of a favor page 900 that may be generated, for example, by selecting the “send your favor” button in FIG. 7. In one embodiment, the information entered into favor input user interface 600 may be displayed, including, but not limited to status 902, description 910, need by 912, privacy preferences 914, response selectors 904, or the like.

In addition, information such as widgets, for example, the money meter described above for a fund-raising favor, may also be included. However, the invention is not limited to this embodiment and other types of information may be included based on the template chosen, based on a variety of other factors, including, for example, selections by the user.

Favor page 900 may also include response section. In one embodiment, a user may be allowed to employ response selector 904 to select different types of responses to the favor, including, for example, yes, no, or maybe. Optionally, a user may additionally include response comments. The recipient may then employ submit selector 905 to submit their response to the favor, which may, in one embodiment, virtually at once, display their response in peep list 920, and/or as part of a summarization of responses 921. As illustrated, the responses may be summarized based on a type of response: yes, no, maybe, no reply, or the like. However, in another embodiment, the responses may be grouped by order of response, yes or otherwise, or the like.

Favor page 900 may also include discussion forum 908. Discussion forum 908 may provide a way for recipients to request or provide additional information, questions, comments, concerns, responses, or the like. Contacts may post to discussion forum 908 anonymously or may log-in to identify themselves. Additionally, the user may select to allow anonymous posting, allow anonymous posting with tracking (such as IP address logging, or the like), restrict anonymous posting, or the like. In one embodiment, the contact may enter their responses, comments, or the like, using a text window, such as 906. However, other mechanisms may also be used, including selecting from a menu of defined response comments, or the like.

Moreover, as noted above, in at least one embodiment, favor page 900 may display targeted advertisement 918 to the contact. The advertisement may be targeted to the particular contact currently viewing favor page 900 based, for example, upon the requested favor, and/or information determined about the viewer from their comment/responses to the favor, and/or information obtained from log-in information. However, in another embodiment, the advertisement might have been selected for a general display to virtually any contact, based on input from the favor requestor, and/or other criteria. In still another embodiment, advertisements might not be displayed on favor page 900.

Based in part on the list of recipients and/or others responding to favor page 900, the author of favor page 900 may be provided with an ability to rank or otherwise provide a recipient/user ranking based on qualitative and/or quantitative characteristics. These characteristics include, but are not limited to a frequency of a recipient to responding to favors, a number of fulfilled favors by the recipient, a quality of how well a favor is satisfied, or the like. Such rankings may be maintained separate from favor pages displayed to others, or may be displayed on a webpage managed generally by the author and available for selected others to view, available for general viewing, or the like. In one embodiment, such rankings might be submitted to be combined with rankings from other favor authors, such that a global ranking might be maintained. Such global ranking might then be available for display and/or provide rewards, good will, discounts, or the like, to a subset of the ranked responders.

### Generalized Operation

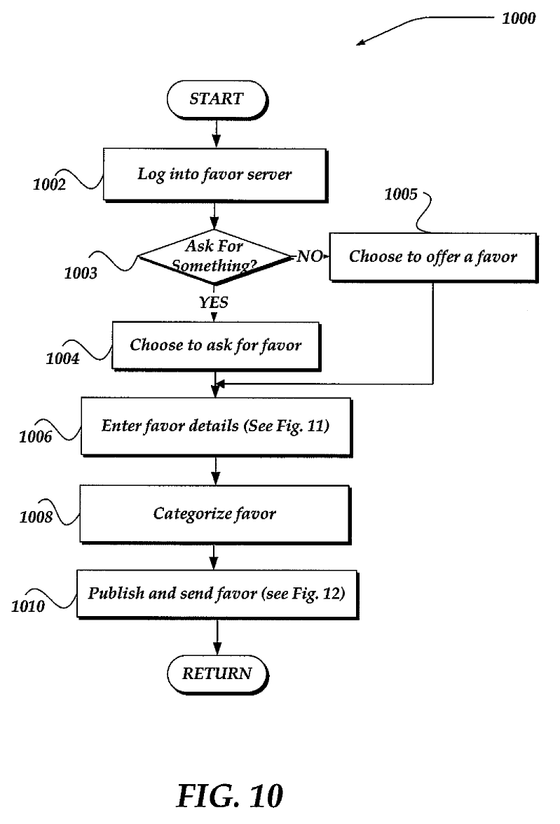

The operation of certain aspects of the invention will now be described with respect to FIGS. 10-18. FIG. 10 illustrates a logical flow diagram generally showing one embodiment of a process for exchanging online favors. Blocks of process 1000 of FIG. 10 may be implemented within different components of system 100 of FIG. 1. For example, block 1002 may be performed within client device 101, while blocks 1003, 1004, 1005, 1006, 1008, and 1010 may be performed by favor management platform 110.

As shown, process 1000 begins, after a start block, at block 1002, where a user may log-in to the favor management platform. In one embodiment, a user may access an entry user interface such as described in conjunction with FIG. 4 and select a “Sign In” link. The user may then enter log-in information, such as a username and password, certificate, or the like, to access the favor management platform. If the user signs in for the first time, the user may be asked to register with the favor management platform. Registration may include providing contact information, interests, intended uses of the favor management platform, preferred privacy settings, preferred contact method, or the like.

Processing then moves to decision block 1003, where a determination is made whether the user requests to ask for a favor or to offer favor. If the user is asking for a favor, processing flows to block 1004; otherwise, processing flows to block 1005.

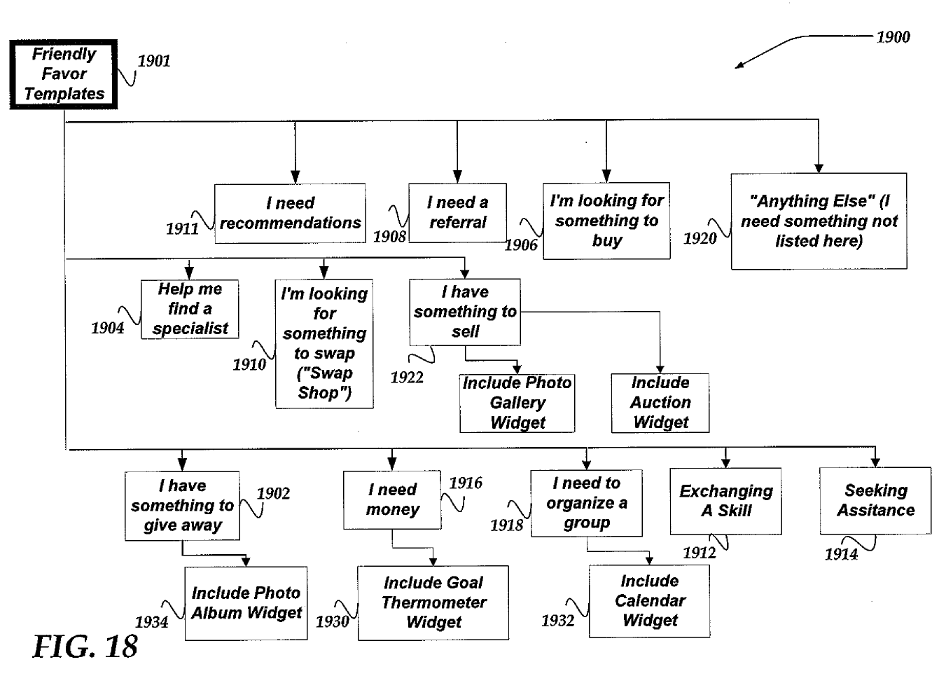

However, the invention is not limited to this embodiment. For example, other options may be selected such as those discussed in more detail below in conjunction with FIG. 18. Briefly, a user may also choose to manage an account, offer a favor, manage favors, respond to a favor, search favors, or the like.

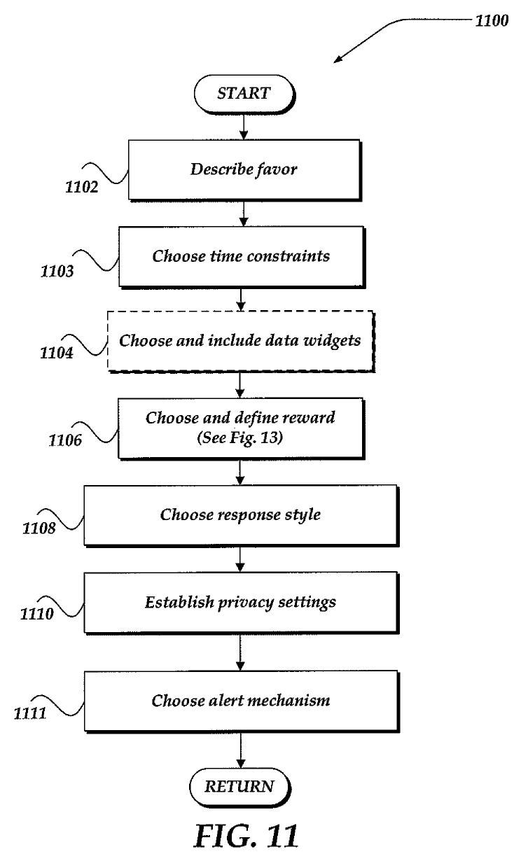

In any event, at block 1004, when the user chooses to ask a favor, processing continues next to block 1006, where the user may be provided with a webpage, or other interface useable to provide one or more favor selection details may be entered regarding a favor. Entering favor details will be described in more detail in conjunction with FIG. 11. Briefly however, in one embodiment, a user may enter information into a favor input user interface such as described in conjunction with FIG. 6. Favor details may include a favor title, description, value, length or duration, privacy preferences, or the like. Similarly, at block 1005, when the user chooses to offer a favor, processing continues to block 1006, where the user may be provided with a webpage, or other interface useable to provide one or more favor selection details for offering a favor.

Upon completion of block 1006, processing flows to block 1008, where the favor is categorized within the favor management platform. The favor may be categorized a find a specialist, buy, sell, referral, recommendations, fluid raising, organize a group, seek assistance, exchange a skill, or the like. These categories may be used to organize an internal database of favors. The invention is not limited to these categories and may include more or less. These categories may additionally be used to aid in searching of favors.

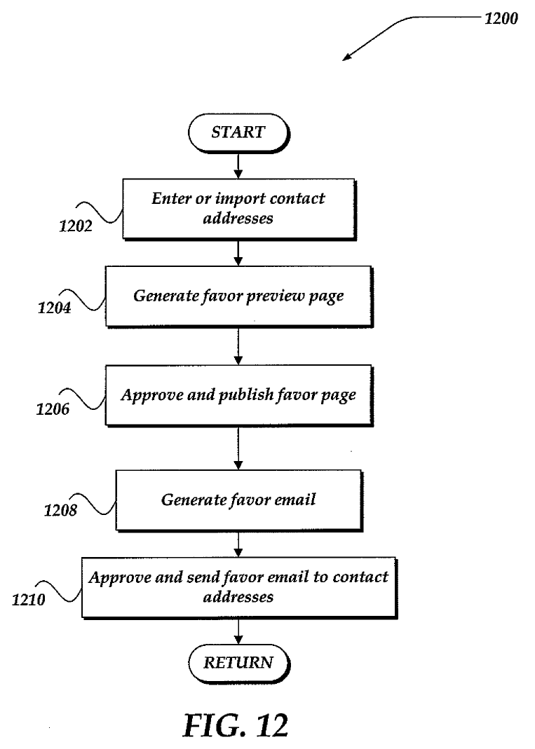

Processing proceeds to block 1010, where the favor is published. Block 1010 will be described in more detail in conjunction with FIG. 12. Briefly however, a favor page and notification message are generated and sent to a user's contacts. In one embodiment, the notification may be automatically sent, independent of additional actions by the user. In another embodiment, the user might select an icon, button, or the like, to send the notification message. The notification message may be in the form of an email, a text message, an SMS message, a message on a pager, a voicemail, an alert from a management interface in the form of a pop up, sound, notifier, or the like. A contact may then access the favor page using a link, code, or the like within the notification message. Process 1000 may then return to a calling process to perform other actions.

FIG. 11 illustrates a logical flow diagram generally showing one embodiment of a process for entering favor details. Process 1100 of FIG. 11 may be employed as one embodiment of block 1006 of FIG. 10. However, other embodiments may also be employed for block 1006, without departing from the scope of the invention. A user may enter favor details into a favor input user interface such as described in conjunction with FIG. 6. Favor details may include a favor title, description, value, length or duration, privacy preferences, or the like.

Process 1100 begins, after a start block, at block 1102, where a favor is described. Describing a favor may include defining a title, defining a description providing additional information about the favor, selecting a photo, or the like. Describing a favor may also include defining a favor type and entering information appropriate to that type. Briefly, favor types include finding a specialist, looking to buy something, needing a referral, needing a recommendation, having something to sell, needing money for fund raising, sponsorship, or the like, needing to organize a group, exchanging a skill, seeking assistance, or the like.

Processing moves next to block 1103, where a length of time or duration during which the favor is active, a requested response deadline, or the like is specified. A favor page may expire or become inactive based on, at least in part, a length of time, duration, completion, deletion, or the like. In one embodiment, a favor page may be locked after the duration, completion, deletion, or the like and/or archived.

Processing moves next to block 1104 where widgets may optionally be included (as indicated by the dashed box). Widgets may include calendars for scheduling, money meters for tracking money raised, spreadsheets, graphs, photos, documents, maps, checklists, carpools, graphical animations, or the like. In one embodiment, widgets may be modified by contacts to organize information offered by the contacts.

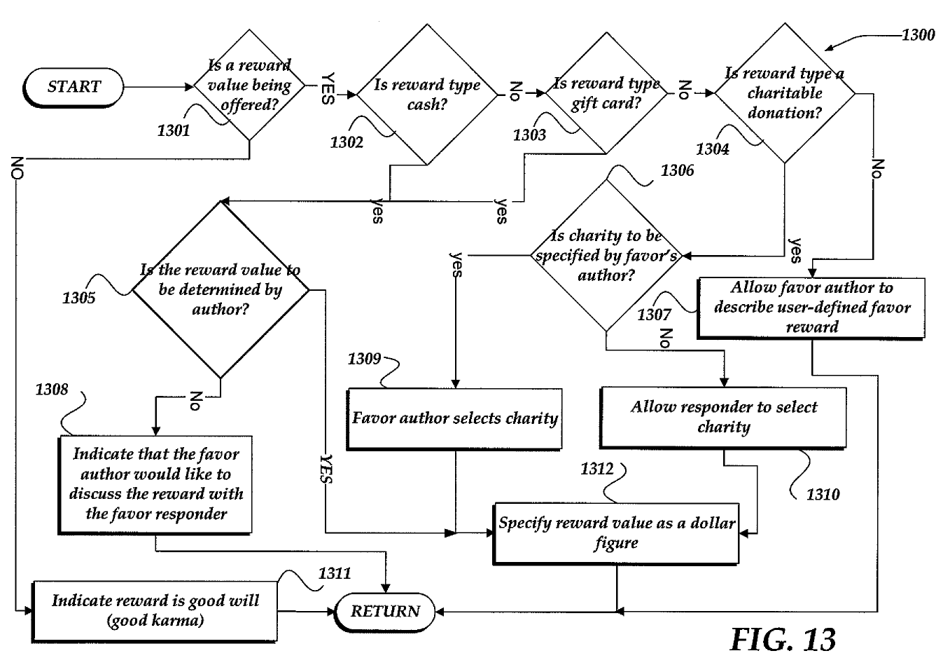

Processing then flows to block 1106, where a reward type is chosen. The reward type may be in the form of cash, a gift card, good will (“Good karma”), or the like. The reward type and value selection process is illustrated more detail below in conjunction with FIG. 13.

Processing flows next to block 1108 where a response style is chosen. Responses may be an open forum, such as described in conjunction with FIG. 9, confined to a widget, a survey question, or the like. A user may also select other response options such as allowing or not allowing anonymous responses. If anonymous responses are not allowed, a contact must be identified to post to a discussion forum. A contact may be identified via login information, a code from the notification message, or the like. If anonymous responses are allowed, a user may choose whether to employ tracking, such as IP address logging, or the like, to monitor responses.

Processing then flows to block 1110 where a privacy setting is established. A user may ask that contacts not forward the favor, ask that contacts only forward to trusted contacts, ask to forward to all contacts, ask to be posted publicly within the favor management platform, or the like. In one embodiment, if a user asks that contacts not forward the favor, the favor management platform may secure the page such that it is only viewable to authorized parties. In another embodiment, if a user asks the favor to be posted publicly, the favor management platform may post the favor to be viewable by anyone. The favor may then also be available using the search function. If a user asks that contacts forward the favor to a trusted contact, the user may additionally set a limit on the “degrees of separation” from the user a contact for which the favor is to sent to should be. As an example, a contact the user knows personally is separated from the user by one degree of separation. A contact known by a first degree of separation contact is separated from the user by two degrees of separation, and so on. The favor management platform may track the path of a favor notification message, using information in the header, or the like. The tracked information may then be used, at least in part, to verify whether a contact is able to access a favor page. The favor management platform may also allow a contact to enter additional contacts within the favor management platform to forward the favor. In this way, the favor management platform may control access to a favor page, based on privacy settings.

Processing then flows to block 1111 where an alert mechanism is established. Settings may include, but are not limited to the type of response requested from contacts. For example, a user may request that contacts reply by posting to the favor page forum, calling, text messaging, SMS messaging, emailing, or the like. If a user requests a call or email, relevant personal information may be included on the favor page and/or notification message.

Entering favor details is not limited to these options. In one embodiment, a user may set a personal notification level. For example, a user may choose to be notified when a contact responds to a favor, modifies the favor page in any way, never, or the like. In another embodiment, a user may choose to receive notifications immediately, daily, weekly, or the like, if there has been activity on a favor page. In yet another embodiment, a user may choose a type of notification. For example, a user may wish to receive an email, a text message, an SMS message, a message on a pager, a voicemail, an alert from a management interface in the form of a pop up, sound, notifier, or the like, no notification, or the like. In another embodiment, a user may also choose display options such as background color, text color, font, font size, graphic designs, skins, or the like. Process 1100 then returns to a calling process to perform other actions.

FIG. 12 illustrates a logical flow diagram showing one embodiment of a process for publishing and sending a favor. Process 1200 of FIG. 12 may be employed as one embodiment of block 1010 of FIG. 10. However, other embodiments may also be employed for block 1010, without departing from the scope of the invention.

Process 1200 begins, after a start block, at block 1202, where contact addresses are entered. Contact addresses may be entered manually, from an address book within the favor management platform, imported from an address book from an external email client, such as Outlook, Eudora, Hotmail, Gmail, Yahoo! mail, or the like. The address book within the favor management platform may be populated using any of the mentioned methods. Additionally it may retain information for contacts previously sent favors by the user. However, the invention is not limited to this embodiment. For example, contact addresses may be imported from a social networking site such as MySpace, Plaxo, Yahoo! User Groups, Friendster, Facebook, LinkedIn, or the like.

In another embodiment, a user may add other users of the favor management platform as contacts or may enter external contact information into a favor management platform address book. Contacts within the favor management platform address book may be grouped in any way chosen by the user. For example, a user may choose work, family, friends, school, or the like. Contacts may rher be divided into geographic locations, or the like. Any grouping system may be employed without departing from the scope of the invention. Once contact addresses are uploaded, a user may select which of the contacts to receive the favor. For example, a user may choose work contacts, social contacts, family contacts, various individual contacts, some combination, or subset of these groups, or the like.

In one embodiment, a user may also choose an order in which to notify contacts. For example, a user may divide known contacts into groups. A first group may initially receive notification of the pending favor. If the favor is still open after a set period of time, a second group may be additionally notified. If the favor is still open after a second set period of time, all contacts known to the user may be notified. If the favor is still open after a third set period of time, a favor may become public. A set period of time may be hours, days, weeks, or the like. More or fewer groups may be used without departing from the scope of the invention. This embodiment does not limit the invention. One of ordinary skill in the art will appreciate that the time frames, groupings, numbers of groups, etc may vary per user, per favor. Additionally, in one embodiment, a user may add additional contacts not included in the initial set of contacts after a favor has been published.

Processing may flow next to block 1204 where a favor preview page is generated. It should be noted, that in one embodiment, the favor preview page may be optional. An example embodiment of a favor preview page is described above in conjunction with FIG. 7. Information is taken from a favor input user interface, such as that described in conjunction with FIGS. 6A-6D, and formatted into a favor preview page. The favor preview page may include, for example, the favor title, description, value, length or duration, privacy preferences, or the like. Additional information, such as a widget (for example the money meter described above for a flud-raising favor, a calendar for an event organization favor, or the like) may also be included. However, the invention is not limited to this embodiment and other types of information may be included.

Processing flows next to block 1206 where the user approves the favor preview page. If the user does not approve the favor preview page, the user may return to the favor input user interface and modify the entered information as necessary. If the user does approve the favor preview page, the user may choose to send (publish) the favor. Processing next flows to block 1208 where a favor notification message is generated. An example embodiment of a favor notification message is described in conjunction with FIG. 8. Processing moves next to block 1210 where the favor notification message is approved by the user and sent to the contacts chosen in block 1202. Notification messages are not limited to this embodiment. Moreover, in another embodiment, at block 1210, the email or other notification message format may be automatically generated and send, without additional actions by the user, including, for example, without the user providing explicit approval of the message. For example, notification messages may be sent as mobile alerts, text messages, SMS messages, messages to a pager, voice mails, management interface alerts, or the like. Process 1200 may then return to a calling process to perform other actions.

FIG. 13 illustrates a logical flow diagram generally showing one embodiment of a favor type and value selection process. Process 1300 of FIG. 13 may represent one possible embodiment, of block 1106 of FIG. 11. However, the invention is not so limited and other process flows, or mechanism may also be used.

Process 1300 begins after a start block, at decision block 1301, were a determination is made whether there is a reward value being offered. As noted elsewhere, reward values may be tangible or monetary, such as cash, an action, or the like, or intangible, such as an expression of good will/karma or the like. Thus, if a ‘tangible’ or a ‘monetary’ reward value is being offered, processing flows to decision block 1302; otherwise, processing flows to block 1311.

At decision block 1302, a determination is made whether the reward type is cash. In the case where the favor describes something being offered, a cash value may be requested in exchange. However, the invention is not limited to these reward types. For example, a reward type may include a donation to a particular charity, a return favor, an exchange of goods or services (swapping favors), or may be open to suggestions, in which case the responder or favor's creator may be asked to suggest the reward type and/or value. Reward types and favor values may be chosen from drop down menus, radio buttons, pre-defined options, entered manually, or the like. In one embodiment, if a donation, gift card, or the like reward type is chosen, featured vendors may be available in a drop down menu. Further, a user may set a preference to include or exclude a particular vendor. The favor management platform may also provide previously used vendors (by a user) to the particular user for future use. In any event, if the reward type is cash, processing flows to decision block 1305; otherwise, processing flows to decision block 1303.

At decision block 1303, a determination is made whether the reward type includes a gift card. If so, processing flows to flows to decision block 1305; otherwise, processing flows to decision block 1304, where a determination is made whether the reward type is a charitable donation. If the reward type is a charitable deduction, processing flows to decision block 1306; otherwise, processing flows to block 1307.

At decision block 1305, a determination is made whether the reward value is to be determined by the author. If not, then processing flows to block 1308; otherwise, processing flows to block 1312.

At block 1308, the author may indicate that the author is open to discussing the reward with the favor responder. That is, the author may have a favor, such as providing a vehicle, furniture, toys, or the like, that the author does not have a defined value determined. In such a non-exhaustive example, the author may be open to discussing best-offers, or the like. For example, in one embodiment, the author might suggest that respondents bid on the favor, thereby enabling others to establish a reward value to the favor. Block 1308 is not limited to bidding approaches, however, and other mechanisms may also be used. In any event, upon completion of block 1308, process 1300 may return to a calling process to perform other actions.

At block 1307, the author may describe other favor rewards that may be desired. For example, a user may describe a type of return favor, such as offering to teach a skill provide a service, or the like. Moreover, the author may also describe constraints upon the return favor, such as time limit, amount of time required, or the like. In any event, upon completion of block 1307, process 1300 may return to a calling process to perform other actions.

At decision block 1306, a determination is made whether the charitable donation is to be specified by the author, by the responder, or the like. If the author is to specify the charity reward, processing flows to block 1309. If the responder is to be permitted to specify the charity reward, processing flows to block 1310. Thus, at block 1309, the author may describe and/or select the charity for the reward to be provided. At block 1310, the responder is allowed to specify the charity for the reward. In either instance, block 1309 or 1310, processing then flows to block 1312.

At block 1312, if a monetary reward type is chosen (including, but not limited to cash, a gift card, a donation, or the like), the author may set the amount. Additionally, the author may select to have the monetary value increment or decrement over time. For example, the author may desire help painting a room. An initial cash value reward may be set at $50 with an additional $50 each day the favor remains opens. If a contact agrees to help paint the room 72 hours (3 days) after the favor is created, the contact may receive a $150 cash reward. Note that the invention is not limited by this example. The cash value and increment value may vary over amount and time and the reward type may vary over any of the reward types. Upon completion of block 1312, process 1300 may return to a calling process to perform other actions.

At block 1311, the author may indicate that the reward is good will, good karma, or the like. As used herein, the terms “good will” and “good karma” refer to an external expression of kindness, appreciation, friendliness, and/or benevolence towards another. Good will or karma may result in a change in a relationship between entities, a change in a reputation of an entity, or even a change in a sense of worth and/or well being. Such good will or karma may be expressed or otherwise provided to the responder through a variety of mechanisms. For example, the author may agree to post or otherwise provide a letter, notice, or the like, that expresses the author's appreciation of the responder. Such letter, or the like, may be posted on a webpage, useable within a resume, or other reference, or the like. In another non-exhaustive example, good will or karma may be provided through a simple thank you, including in a verbal, and/or written form. The good will/karma, or the like, may also be documented and/or provided through other mechanisms. For example, the responder's name, photograph, or the like, might be posted on a webpage indicating how many times the responder has ‘helped’ others with favors, or the like. Such count of times might be useable to rank order the list of ‘good Samaritans,” or the like. In another embodiment, a subset of the good Samaritans might be selected by authors, or through another mechanism, to receive a recognition dinner, a recognition plague, or other form of recognition of their good will. The invention is not limited to these non-exhaustive examples of indicating and/or providing good will/karma, and others may also be employed. In any event, upon completion of block 1311, processing returns to a calling process to perform other actions.

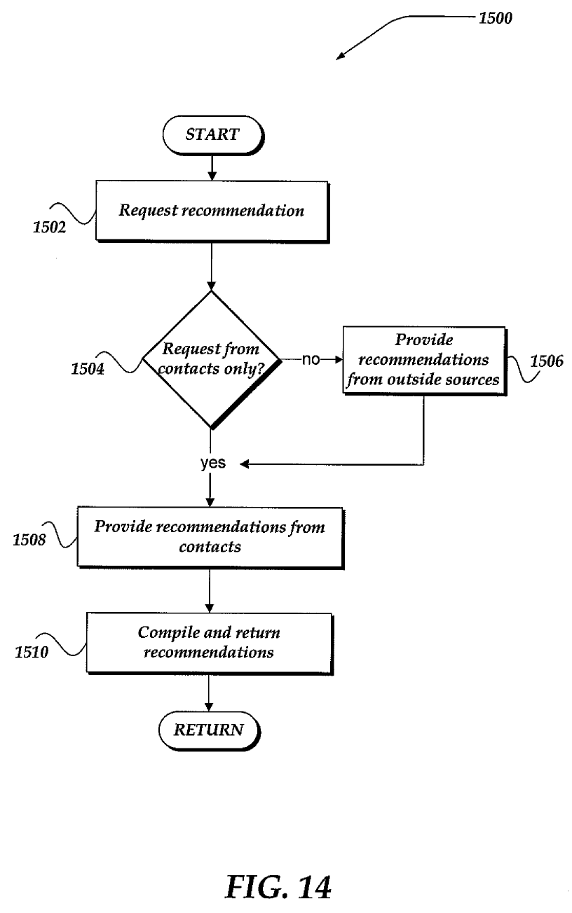

FIG. 14 illustrates a logical flow diagram showing one embodiment of a process 1500 for providing recommendations. Process 1500 begins, after a start block, at block 1502, where a user requests a recommendation. Note that the invention is not limited to this embodiment. For example, a user may also request a referral, a specialist, an item to buy, or the like.

Processing then moves to decision block 1504 where a determination is made regarding whether the favor should be answered by contacts only. In one embodiment, this determination may be decided based on, at least in part, a selected privacy setting. For example, a favor may be answered by contacts if the user requests contacts not to forward, to forward to trusted friends and/or 3^{rd} parties, or the like. In another embodiment, a favor may not be answered by just contacts if the user requests contacts forward to all, for the favor to be posted publicly, or the like.

If the user does not request that the favor be answered by contacts only, processing flows to block 1506. The favor management platform may provide recommendations, referrals, specialists, items to buy, or the like from outside sources. In one embodiment, these outside sources may pay a fee to be added to a favor page relating to certain recommendations, referrals, specialists, items to buy, or the like. In another embodiment, the outside sources may pay an additional fee if the user uses the outside source recommendation, referral, specialist, item to buy, or the like. The outside sources may be added to a favor page in the form of an advertisement, forum comment, or the like. In one embodiment, recommendations, referrals, specialists, items to buy, or the like from outside sources are retrieved from advertisement server 118 in FIG. 1. Processing then proceeds to block 1508.

If, at decision block 1504, the user requests that the favor should be answered by contacts, processing also flows to block 1508. At block 1508, in this instance, recommendations, referrals, specialists, items to buy, or the like are provided from contacts. In one embodiment, contacts may receive a notification of a pending favor, view the favor page, and provide comments in the forum section of the favor page.

Processing then flows to block 1510, from block 1508, where the recommendations, referrals, specialists, items to buy, or the like are compiled from both contacts and outside sources, if applicable. The recommendations, referrals, specialists, items to buy, or the like may be displayed in the forum section of the favor page, or sent to the user via email, IMN, TXT message, SMS message, message to a pager, voice mail, management interface alert, or the like. Process 1500 may then return to a calling process to perform other actions.

FIG. 15 illustrates a logical flow diagram showing one embodiment of a process 1600 for acquiring revenue for the exchange of favors. In one embodiment, process 1600 may occur on billing server 117 in FIG. 1. Process 1600 begins, after a start block, at block 1602, where a favor is published. Publishing a favor is described in more detail in conjunction with FIG. 12. Once a favor is published, in one embodiment, the favor management platform's billing server may determine whether the specified favor value is monetary. Monetary favor values may be associated with any reward type where money is exchanged, including, but not limited to, cash, gift cards, donations, or the like. If the favor value is monetary, processing flows to block 1606. If the favor value is not monetary, process 1600 returns to a calling process.

At block 1606, in one embodiment, the favor management platform's billing server may determine whether the specified reward type is for profit. For example, cash, gift cards, or the like, may be for profit. In another embodiment, donations or the like may be not for profit. If the reward type is for profit, processing continues to block 1608. At block 1608, a predefined percentage x is deducted from the monetary value of the favor value. If the reward type is not for profit, processing continues to block 1610. At block 1610, a predefined percentage y is deducted from the monetary value of the favor value. In one embodiment, y may be a smaller value than x. For example, a for-profit reward type may be charged 10% (x=10), while a not-for-profit reward type may be charged 5% (y=5). However, the invention is not limited to this example and other values may be used. In either case, process 1600 may then return to a calling process to perform other actions.

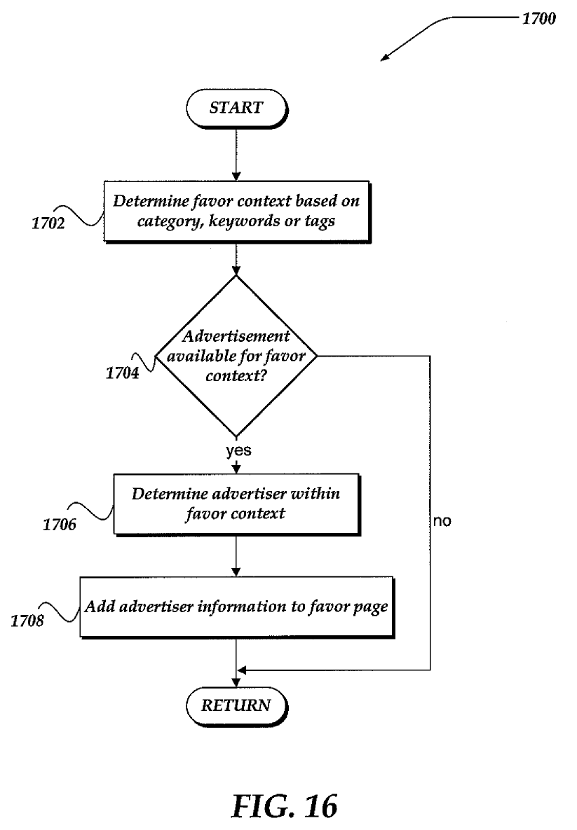

FIG. 16 illustrates a logical flow diagram showing one embodiment of a process for targeting advertisements within a favor page. Process 1700 begins, after a start block, at block 1702, where the favor is categorized within the favor management platform. The favor may be categorized by finding a specialist, buying, selling, referrals, recommendations, fund raising, organizing a group, exchanging a skill, seeking assistance, or the like. The invention is not limited to these categories and may include more or less. These categories may be further subdivided into types of favors with associated keywords. For example, a favor requesting a referral for a painter may be within the “referral” category. This favor may also be further subdivided into a painting category with associated tags or keywords including, but not limited to, painting, paint, decorating, or the like.

Processing then moves to block 1704 where a determination is made whether an advertiser is available in the favor category. An advertiser may be available if an advertiser with products related to the description of the favor is available from advertisement server 118 in FIG. 1. For example, if a user posts a favor requesting help painting a room, products for painting materials may be related to the description of the favor. In one embodiment, if an advertiser for painting material is available within the advertisement server, an advertiser is available for a favor requesting help painting a room. If an advertiser for painting material is not available within the advertisement server, process 1700 returns to a calling process to perform other actions.

If an advertiser is available for the favor category, processing then moves to block 1706, where an advertiser is determined within the category. In one embodiment, keywords associated with a favor may be used to search the advertisement server 118 in FIG. 1. Continuing with the example above, “painting” may be used to locate an advertiser for paint products.

Selection of the advertisement at block 1706 may also be determined based on information about a defined recipient of the favor message notification, or the like. The advertisement may also be selected based on any of a variety of other criteria, including, but not limited to the favor author's history of prior favors, recipient's prior favors, or the like.

Processing proceeds to block 1708, where the advertiser information may be added to a favor page, message notification, or the like, in the form of an advertisement, forum comment, widget, or the like. Process 1700 may then return to a calling process to perform other actions.

FIG. 17 illustrates a logical flow diagram showing one embodiment of a process 1800 for searching for favors within the favor management platform. Process 1800 begins, after a start block, at block 1802, where a user may enter a set of search query parameters. In one embodiment, search query parameters may include keywords, time frame to search (e.g., favors within the last week, three months, two years, or the like), region of search (local, national, global, or the like), scope of search (personal favors, public favors, or the like), or the like. The search query parameters are not limited to those listed here and may include other parameters including, but not limited to, favor value, reward type, or the like. For example, a user may search all public favors with a monetary reward type.

Processing then moves to decision block 1804 where a determination is made whether the search is private. In one embodiment, a search may be determined to be private if a user selects the scope of the search to be directed to personal favors. Personal favors are favors requested by or of a particular user. These favors are considered to be private to the user unless the user agrees to have the favor posted publicly. In another embodiment, a search may be determined to not be private if a user selects the scope of the search to include public favors.

If the search is not determined to be private, processing flows to block 1806. At block 1806, the favor management platform searches an archive of public favors. In one embodiment, favors may be archived when they are completed or closed by a user. In another embodiment, deleted favors may also be archived. Public favors may be any favor where the user agrees to have the favor posted publicly. The favor management platform may use the search query parameters (including, but not limited to, keywords, time frame, or the like) to search the favor archives. Processing continues next to block 1808, where current public favors are searched. Current favors may include any favors still pending. Processing then proceeds to block 1810.

If the search is determined to be private, processing also flows to block 1810. At block 1810, the favor management platform searches an archive of personal favors. The favor management platform may use the search query parameters (including, but not limited to, keywords, time frame, or the like) to search the favor archive, limiting the search to the personal favors of the user. Processing continues next to block 1808, where current personal favors are searched.

Processing proceeds to block 1814, where resulting favors are compiled from both personal favors and public favors, if applicable. The resulting favors may be sorted before being displayed to the user. For example, resulting favors may be ordered by relevance, date of posting, personal/public, or the like. The return favors may then be displayed to the user through a favor view interface such as that described in conjunction with FIG. 5. However, the invention is not limited to this embodiment and other display configurations may be used to return favors. Process 1800 may then return to a calling process to perform other actions.

FIG. 18 illustrates a logical flow diagram showing one embodiment for various favor types that may be asked by a user of the favor management platform. Template flow 1900 may include more or less templates than illustrated. However, the templates shown are sufficient to disclose an illustrated embodiment for practicing the invention.

As shown, a user may select a favor type (templates 1901), in one embodiment, from a template bar, as described in conjunction with FIG. 4. Based, at least in part, on the favor type, a user may enter favor type specific information into a favor input user interface, such as the one described in conjunction with FIG. 6. Favor types include, but are not limited to, having something to give away 1902, helping find a specialist 1904, looking for something to buy 1906, needing a referral 1908, needing recommendations 1911, exchanging a skill, seeking assistance, looking for something to swap 1910, anything else 1920, or the like. The invention is not limited to these user template scenarios. For example, favor types may also include having something to sell 1922, needing money 1916, organizing a group 1918, or the like.

If a user wishes to find a specialist, such as a contractor, doctor, software developer, or the like, the favor input user interface may request specific information. This information may include, but is not limited to, type of specialist, cost of specialist, experience requested, or the like. Additionally, the favor page may include a forum for contacts to discuss various specialists or request further constraints. If a user is looking for something to buy, has something to give away, looking for something to swap, needs a referral, needs a recommendation, or the like, the favor input user interface may request specific information, similar to that described above. This information may include, but is not limited to, a picture of the product, a price range, or the like. For example, in one embodiment, the user might employ a photo album widget 1934. Additionally, the favor page may include a forum for contacts to discuss the favor or request further constraints. In one embodiment, if the user selects “anything else,” 1920 the favor input user interface may request a generic set of information such as a favor title, favor value, privacy preferences, forum for discussion, or the like. In addition, the favor input user interface may be customizable to add additional features such as widgets, length/duration, comments, or the like.

In another embodiment, if a user has an item to sell, the favor input user interface may request a minimum amount for the item, a “sell now” price, or the like. In another embodiment, the favor page may additionally include an auction section, an auction widget, or the like. The auction section, auction widget, or the like may keep a tally of bids, the highest bid, or the like. The favor page may also include a forum for contacts to discuss the item or request further information. If a user needs money, such as for fund raising, sponsorship, or the like, the favor input user interface may additionally request a monetary goal amount. The favor page may then include a money meter widget (such as a thermometer, or the like), or other goal widget 1930, to track the collected money. If a user wishes to organize a group, such as for event planning, meetings, or the like, the favor input user interface may additionally request a scheduling range, scheduling constraints, or the like. The favor page may then include a calendar widget 1932, spreadsheet widget, or the like, to track the responses. In each case disclosed, in addition to those features described above, the favor page, as described in conjunction with FIG. 9, may include a summary section describing the favor, favor value, privacy preferences, forum for discussion, or the like.

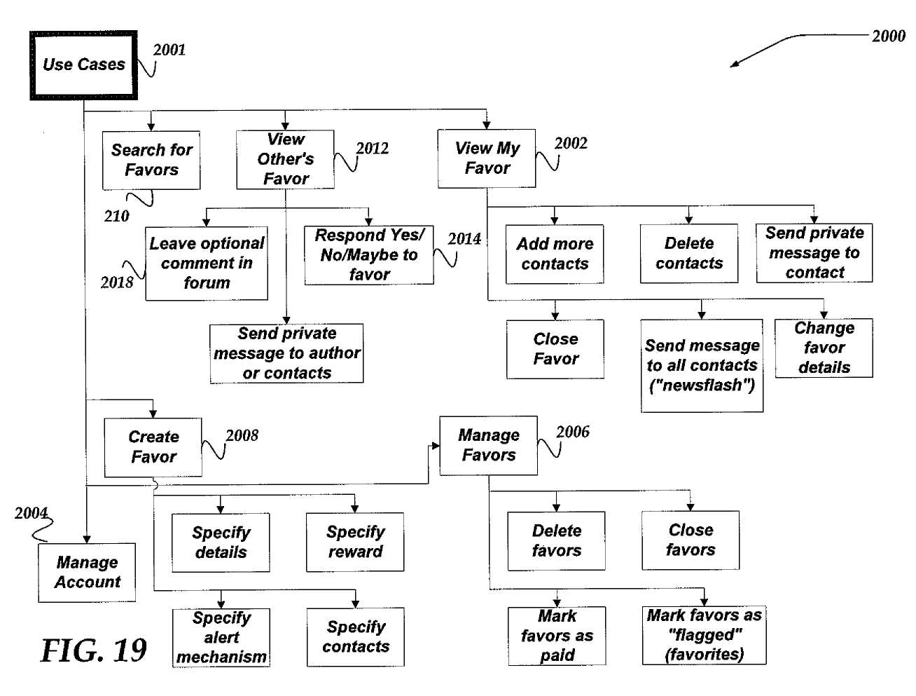

FIG. 19 illustrates a use case flow diagram 2000 showing one embodiment for a set of user scenarios within the favor management platform. A user may enter the favor management platform through the main page 2001 view a favor 2002, manage an account 2004, manage favors 2006, create a favor 2008, search for a favor 2010, view other's favors 2012, respond to a favor 2014, or the like. The invention is not limited to these user scenarios. For example, a user may also receive a favor, ask for a favor, log in or out, leave feedback 2018, read about and/or privacy policies, contact the platform administrators, or the like.

If a user chooses to manage an account 2004, a new webpage, management console, or the like may be displayed. A user may change their personal information, including name, contact email address, phone number, password, or the like, privacy preferences, defaults settings, or the like. The contact email address, phone number, or the like may be used to notify the user when a favor is fulfilled by a contact, when a response is posted within a user's favor forum, or the like. A user may also specify how they prefer to be notified of available favors. In one embodiment, a user may select to receive emails, mobile alerts, text messages, SMS messages, messages to a pager, voice mails, management interface alerts, digital dashboard alerts, or the like.

If a user wishes to create a favor 2008, the user may post a favor in exchange for monetary reward, future return favors, good will, or the like. In one embodiment, the user may begin with a favor template, a previously created favor, a blank favor, or the like. If a user asks a favor, the user may follow a flow such as that described in FIGS. 10-12. If a contact receives a notification message of an available favor, the contact may click on a link, enter a code, access a digital dashboard, or the like to access the favor page.

If a user wishes to manage favors 2006, the user may manage favors asked by creating a new favor, viewing a favor, updating a favor, closing a favor, deleting a favor, accepting a favor, or the like. Updating a favor may include adding or removing further favor details, adding contacts, or the like. A contact may also manage favors asked of the contact. The contact may see favors answered and change a response, see favors not yet answered and respond to the favor, or the like. If the contact chooses to respond to a favor, the contact may respond positively, negatively or uncertainly. In any case, the user may offer or request additional information. In one embodiment, a new webpage, management console, or the like may be displayed to manage favors. The webpage, management console, or the like may display all favors requested by and of the user. Each favor may include information such as, but not limited to, title, date created, value, expiration date, status, last response, an unread indicator, an update indicator, outstanding tasks such as a pending return favor, or the like. Again, it should be noted that the invention is not constrained by the above non-exhaustive use case, and other uses of the invention may be employed resulting in different flows through the processes, templates, and/or the like. Thus, the above use case is not to be construed as narrowing the invention.

It will be understood that each block of the flowchart illustration, and combinations of blocks in the flowchart illustration, may be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, may be implemented by special purpose hardware-based systems which perform the specified actions or steps, or combinations of special purpose hardware and computer instructions.

The examples provided should not be construed as narrowing the embodiments of the invention, and are intended merely to provide a better understanding. Thus, other mechanisms may therefore be employed, without departing from the scope of the invention.

The above specification, examples, and data provide a complete description of the manufacture and use of the composition of the invention. Since many embodiments of the invention may be made without departing from the spirit and scope of the invention, the invention resides in the claims hereinafter appended.

What is claimed as new and desired to be protected by Letters Patent of the United States is:

1. A computer system configured to provide a graphical user interface for display over a network to a client device, the computer system having computer executable instructions for enabling a transaction exchange by performing actions, comprising:
receiving a description of a favor over the network through an interface screen displayable at the client device;
receiving a selection of a reward from within a plurality of selectable rewards for satisfying the favor, the plurality of selectable rewards including at least a selection of good will;
receiving a list of contacts that are to be notified of the favor;
automatically generating a webpage for display of the favor description and the selected reward; and
sending a favor notification to each contact in the list of contacts, such that at least one contact is enabled to access the generated webpage to respond to the favor.

2. The computer system of claim 1, wherein receiving the list of contacts further comprises receiving a privacy constraint for favor, wherein the privacy constraint indicates at least one of information about the favor is not to be forwarded, information about the favor can be forwarded to anyone, or that information about the favor can be forwarded based on a trust relationship.

3. The computer system of claim 1, wherein the selectable rewards further include at least one of cash, gift card, charitable donation, a return of a favor, a service, or a swap.

4. The computer system of claim 1, wherein the favor comprises at least one of a request for or an offer for at least one of a good, or a service.

5. The computer system of claim 1, wherein automatically generating a webpage for display of the favor and selected reward further comprises:
displaying an advertisement for display within the webpage, wherein the advertisement is selected based in part on a category of the favor.

6. The computer system of claim 1, wherein receiving a description of a favor over the network through a displayable interface screen further comprises, providing a template useable for entering the description of the favor based on a category of the favor.

7. A network device to managing transactions over a network, comprising:
a transceiver to send and receive data over a network; and
a processor that is operative to perform actions, comprising:
receiving from a client device, a description of a favor to be satisfied, the favor including at least one of a request or an offer of a good, or a service;
receiving from the client device, a description of a reward for satisfying the favor, the description being selectable from a plurality of rewards that includes at least a reward of good will; and
publishing the descriptions of the favor and reward to a specified set of contacts, such that the publication enables at least one contact to respond to the favor.

8. The network device of claim 7, wherein publishing the description further comprises sending an electronic notification to each contact in the set of contacts, wherein the electronic notification further includes a mechanism for accessing a webpage that includes the descriptions of the favor and the reward.

9. The network device of claim 7, wherein publishing further comprises providing a webpage that includes the descriptions of the favor and the reward and further comprises a mechanism that enables at least one contact in the specified set of contacts to provide at least one of a response to the favor, or a comment to the favor, and wherein the webpage further provides statistical information about responses received.

10. The network device of claim 7, wherein publishing further comprises:
determining a category for which the favor is associated;
selecting an advertisement based on the determined category; and
displaying the selected advertisement within the webpage.

11. The network device of claim 7, wherein receiving from the client device, a description of a reward further comprises:
if the reward is determined to be non-monetary, receiving a description of good will that includes at least posting information about a person satisfying the favor at a webpage that is publicly available;
if the reward is determined to be a gift card, enabling at least the person creating and sending the favor to select the gift card for the person satisfying the favor or allowing the person satisfying the favor to select the gift card;
if the reward is determined to a charitable donation, enabling at least the person satisfying the favor to select a charity for the reward; and
if a value of the reward is undetermined at a time of publishing the favor, enabling the person satisfying the favor to suggest a value of the reward.

12. The network device of claim 7, wherein the processor that is operative to perform actions, comprising:
determining if the reward type is a monetary reward, and if the reward type is a monetary reward:
determining if the reward is directed towards profit for a person satisfying the favor, and if the reward is directed towards profit, charging a first percentage of a monetary value of the reward to be provided to an owner associated with the network device; and
determining if the reward is a donation to other than the person satisfying the favor, charging a second percentage of the monetary value of the reward; and
if the reward type is a non-monetary reward associated with good will, inhibiting charging.

13. A processor readable storage medium that includes data and instructions, wherein the execution of the instructions on a computing device provides for managing exchanges over a network by enabling actions, comprising:
providing to a client device at least one user interface display useable at the client device to enter a description of a favor and a reward to be exchanged for the favor, wherein the user display also provides for the reward to good will in addition to at least a good or a service;
receiving a description of the favor and the reward from the client device over the network;
receiving at least one address for a contact;
automatically generating a favor web page having the description of the favor and the reward; and
sending a notification of the favor to at least one address, such that the notification enables the contact to access the favor web page.

14. The processor readable storage medium of claim 13, wherein the favor web page further includes privacy information indicating at least one of whether the contact may forward information about the favor to others, whether the contact is restricted from forwarding information about the favor to others, or whether the contact may forward information about the favor to at least one other contact for which the contact trusts.

15. The processor readable storage medium of claim 13, wherein the favor is categorized and an advertisement is determined for display within the favor web page based on the categorization, or information about the contact.

16. The processor readable storage medium of claim 13, wherein execution of the instructions further enable actions, comprising:
if the reward is a monetary reward, determining a percentage of the reward to be charged at least for managing the exchange of the favor and the reward.

17. A method for managing social networking relationships over a network, comprising:
receiving at a client device at least one user interface display useable at the client device to enter a description of a favor and a reward to be exchanged for the favor, wherein the user display also provides for the reward to good will in addition to at least a good or a service;
in response, sending a description of the favor and the reward from the client device to a server;
sending a plurality of contact addresses of contacts to be notified of the favor;
automatically generating a favor web page having the description of the favor and the reward; and
sending a notification of the favor to the plurality of contact addresses, such that the notification enables at least one contact to respond to the favor.

18. The method of claim 17, wherein the favor is at least one of asking for or offering at least one of a good, a service, or good will.

19. The method of claim 17, wherein the favor includes at least one swappable good or service.

20. The method of claim 17, further comprising:
when a contact responds to the favor, providing an alert message to the client device.
